(19) United States
(12) Patent Application Publication
(10) Pub. No.: US 2023/0289865 A1
(43) Pub. Date: Sep. 14, 2023

(54) EVENT-DRIVEN ARCHITECTURE FOR SCHEDULING ELECTRONIC TRANSFERS

(71) Applicant: Stripe, Inc., South San Francisco, CA (US)

(72) Inventors: Dheeraj Mangi Lal Agrawal, Cupertino, CA (US); Jiajie Chen, San Jose, CA (US); Dylan Symington, Arlington, VA (US); Hannah Sun, Germantown, MD (US); Ruslan Rakhmedov, Aliso Viejo, CA (US); William Melani, Seattle, WA (US); Yixi Zhang, San Mateo, CA (US)

(21) Appl. No.: 17/689,738

(22) Filed: Mar. 8, 2022

(51) Int. Cl. G06Q 30/06; G06N 3/08

(52) U.S. Cl. CPC G06Q 30/0635; G06N 3/088

(57) ABSTRACT

In an example embodiment, a solution is provided that provides an event-driven architecture for scheduling electronic transfers, rather than data-model driven architecture. Doing so allows for the payout portion of the architecture to avoid aggregating transactions—it only needs to obtain an aggregated total (specifically a current balance) once, and thus does not need to be continuously aggregating/checking the aggregation of many transactions simultaneously. The payout portion of the architecture can then forego the traditional ingestion mechanism, which means that it can avoid scanning transaction data.

### TECHNICAL FIELD

The subject matter disclosed herein generally relates to electronic transfers. More particularly, the subject matter disclosed herein relates to an event-driven architecture for scheduling electronic transfers.

### BACKGROUND

Electronic transfers involve moving value (typically money) from one account to another account via a computer network. When the transfer involves a transaction that includes the purchase of a good or service, often there can be a middle entity in between the purchaser (buyer) and the purchasee (seller). For example, the middle entity may accept a transfer of funds from the purchaser and then at some point later transfer an equal amount of funds to the purchasee. An example of a middle entity would be a credit card processor.

Rather than transfer the amount of funds to the purchasee immediately or even in individual transactions, often the middle entity will decide to transfer aggregated funds. This is especially true with high-volume sellers. For example, a high-volume seller may have a thousand transactions in an hour, and in such cases it is more efficient for the middle entity to transfer a single transaction of aggregated funds for all thousand transactions at once, rather than initiate a thousand different transfers.

A technical issue is created, however, for such high-volume purchasees. Specifically, the transactions from the purchasers need to be ingested and aggregated prior to an aggregated payout to be made to the purchasee. This can create a bottleneck, because it can be difficult to ingest and aggregate a large number of transactions while additional transactions are still being made, without losing accuracy of the aggregation. Thus, additional checks must be made to ensure accuracy, which only slows ingestion and aggregation down even more. Such checks often involve managing state transitions, as well as managing various products' logics that can be added into or adapted with a disbursement model, such as deferred debiting, fee discounts, risk reserves, and anticipation repayments. The result is that scaling becomes difficult.

### BRIEF DESCRIPTION OF THE DRAWINGS

Some embodiments are illustrated by way of example and not limitation in the figures of the accompanying drawings.

FIG. 1 is a diagram illustrating a system for scheduling electronic transfers, in accordance with some example embodiments.

FIG. 2 is a flow diagram illustrating a method of generating and monitoring events in a computer system, in accordance with some example embodiments.

FIG. 3 is a block diagram illustrating a representative software architecture, which may be used in conjunction with various hardware architectures herein described.

FIG. 4 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In an example embodiment, a solution is provided that creates an event-driven architecture rather than a data-model driven architecture. Doing so allows for the payout portion of the architecture to avoid aggregating transactions—it only needs to obtain an aggregated total (specifically a current balance) once, and thus does not need to be continuously aggregating/checking the aggregation of many transactions simultaneously. The payout portion of the architecture can then forego the traditional ingestion mechanism, which means that it can avoid scanning transaction data. Previously, part of the bottleneck was caused by the need to sweep many collections across all merchant shards; that process is no longer needed. Additionally, payout attribution, which typically involved the generation and presentation of payout reports, is also separated from the payout portion of the architecture. This eliminates some of the issues with prior solutions due to their mechanism for generating attribution reports, which required too many database writes in scheduling and execution, and an inability to support manual or instant payouts, because every attribution item was a 1-to-1 mapping to a transaction (which prevented breaking a transaction down into smaller portions).

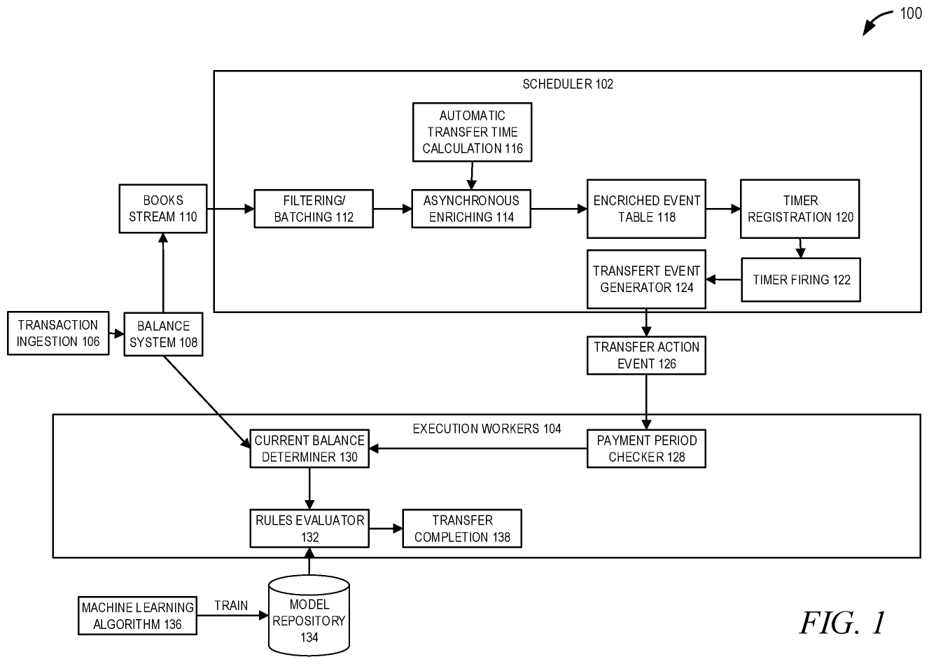

FIG. 1 is a diagram illustrating a system 100 for scheduling electronic transfers, in accordance with an example embodiment. The system 100 includes a scheduler 102 and execution workers 104. Transaction ingestion 106 is a component that ingests transactions to be processed from one or more sources. These transactions are processed by a balance system 108, which maintains a current balance for each merchant. Processed transactions may then be fed as a books stream 110 to a filtering/batching 112 component in the scheduler 102. The filtering/batching 112 component may perform filtering of the transactions as well as batching them together. It should be noted, however, that these operations are optional, as the scheduler 102 is designed so that it is capable of scheduling electronic transfers for merchants as soon as a first transaction for the merchant has been processed. In other words, the scheduler 102 can begin scheduling an electronic transfer for a merchant as soon as a single transaction for the merchant is processed, and then additional transactions may be processed for that merchant and reflected in the ultimate total that is transferred during the scheduled electronic transfer. The result is that the scheduler 102 is not held back from scheduling electronic transfers due to any bottlenecks in the ingestion process.

In light of the above, the filtering/batching 112 component can indeed batch together transactions (which involves waiting for a group of transaction to be processed), but can also choose to not batch together transactions (such as if bottlenecks are being detected). Regardless of whether batching occurs, the output of the filtering/batching 112 component is an event indicating one or more transactions have been processed, which are part of group of transactions (some of which not having been processed yet) that are to be considered part of a single electronic transfer to be scheduled.

Each of these events may then be enriched using an asynchronous enriching 114 component. Enrichment involves addition of additional fields and corresponding field values to the events. In this case, the additional field may be a field corresponding to a time that the next electronic transfer for the corresponding merchant should be scheduled, the field value for that field will be the time itself. This scheduled time may be calculated by an automatic transfer time calculation 116 component. The automatic transfer time calculation 116 component may base its calculation on a set of rules and information about the merchant corresponding to the event being enriched, as well as the current time. For example, there may be a table indicating how frequently each merchant should have their electronic transfers scheduled (e.g., once every three days, once a week, once a month, etc.). The automatic transfer time calculation 116 component may then identify the current date to determine when the correct date is to schedule the electronic transfer for the merchant. Alternatively, the rules may be more complex, such as customizing or personalizing the gap between when the electronic transfer is begun and when it completes.

It should be noted that the enrichment may also include adding fields not related to the timing of the next electronic transfer for the corresponding merchant. For example, the enrichment may also add fields for balance parameters (merchant, mode, currency, balance type), payout plans, and merchant gateways, among other parameters.

The output of the asynchronous enriching 114 component is then stored in an enriched event table 118, which is keyed on (merchant, mode, currency, expected arrival date). A table being keyed on a particular variable or variables means that the table is stored in such as way that a row of the table can be retrieved based on the value or values of the variable or variables. Thus, a table being keyed on merchant, for example, would store a merchant identifier with each row, allowing for quick retrieval of data associated with a particular merchant identifier.

A timer registration 120 component then registers a timer (or updates a timer) based on the enriched event table. A timer firing 122 process then fires a timer at the appropriate date/time. It should be noted that the appropriate date/time to fire the timer may not be the same as the scheduled date/time for the corresponding event for the merchant. Some types of electronic transfers take more time than others to process; the goal is for the electronic transfer to be completed at the scheduled date/time for the corresponding event (i.e., the one stored in the enriched event in the enriched event table 118). For example, an Automated Clearing House (ACH) transaction may take one business day to process after initiation, and thus, if the transaction is supposed to be completed on May 21^{st}, it must be initiated on May 20^{th} (assuming both dates are business days; if not, it may need to be initiated earlier).

Once the timer fires, a transfer event generator 124 may generate a transfer action event 126 to begin the electronic transfer process. Execution workers 104 receive the transfer action event 126, and a payment period checker 128 checks the payment period in the transfer action event 126 to double check that the payment period matches parameters for the merchant. If so, then a current balance determiner 130 obtains a current balance for the merchant from the balance system 108. Notably, as discussed earlier, the current balance for the merchant may be different than it was at the time the transfer action event 126 was created by the scheduler 102, reducing the impact of any bottleneck in the transaction ingestion 106 or balance system 108.

A rules evaluator 132 then uses the current balance to determine how and whether to complete the electronic transfer for the merchant, based on a set of rules. These rules may either be static rules, or may be part of a model stored in a model repository 134. As will be described below, the model may be learned by a machine learning algorithm 136.

Examples of such rules include tests for whether the electronic transfer should occur (i.e., whether the merchant should receive a payout, which may be impacted by such things as balances due, transaction-based risk reserve balance, pre-funding balance), the mechanism by which the electronic transfer should occur (e.g., ACH transaction, SWIFT transaction, wire transfer, etc.), which may be impacted by things such as merchant location (e.g., country, which may have its own banking rules), and the amount to be transferred (which may be impacted by things such as a need to break large transactions into smaller ones for various accounting/banking needs, such as a rule to have no electronic transfer larger than $100,000 per day, requiring a larger transfer to be broken into smaller ones). It should therefore be noted that while FIG. 1 depicts a transfer completion 138 event, in some circumstances this event may not be generated (e.g., if the transfer is cancelled) or may be delayed (e.g., if some or all of the transfer needs to be delayed). Other example rules include offsetting debits with outstanding reserves and offsetting debits with pre-funding top-ups.

The rules may also be machine-learned as part of a model stored in model repository 134. The machine learning algorithm 136 may train the model by first obtaining training data from a data source (not pictured). In some example embodiments, the training data is initially stored in a Hadoop cluster and comprises information on previous attempted electronic transfers for merchants as well as general merchant information (e.g., industry, country, etc.).

The training data may also be preprocessed including, for example, applying a MapReduce function or similar functionality on the training data. A feature extraction component (not pictured) may then act to extract a plurality of features from the preprocessed training data and feed these features into the machine learning algorithm 136. The machine learning algorithm 136 learns weights assigned to each of the features and applies these weights to a function. The function and the learned weights comprise the model.

The machine learning algorithm 136 may be selected from among many different potential supervised or unsupervised machine-learning algorithms. Examples of supervised machine-learning algorithms include artificial neural networks, Bayesian networks, instance-based learning, support vector machines, random forests, linear classifiers, quadratic classifiers, k-nearest neighbor, decision trees, and hidden Markov models. Examples of unsupervised machine-learning algorithms include expectation-maximization algorithms, vector quantization, and information bottleneck methods. In an example embodiment, a binary logistic regression model is used. Binary logistic regression deals with situations in which the observed outcome for a dependent variable can have only two possible types. Logistic regression is used to predict the odds of one case or the other being true based on values of independent variables (predictors). In a further example embodiment, a boosted tree gradient descent process is utilized for the machine learning.

The model may also be periodically retrained, using new training data that may be preprocessed in the same or a similar way. This new training data may include, for example, results from execution of past electronic transfers (e.g., whether the electronic transfer was successful or delayed, feedback from merchants regarding the electronic transfer).

The scheduler 102 provides a high-performance, reliable, stateful scheduling system, which supports timers natively, allowing electronic transfers to be triggered at designated times. The scheduler 102 can also partition the input stream, union multiple streams, and transform the streams into a single format, which allows new transfer flows to be integrated much easier than prior art solutions.

In some example embodiments, the scheduler 102 may also produce a side output, specifically an event indicating that a schedule entry has been created. This allows for the creation of a table that can be queried to find created entries, as well as to bootstrap the scheduler 102 from scratch so that all pending schedule entries can be restored in the case of a system failure.

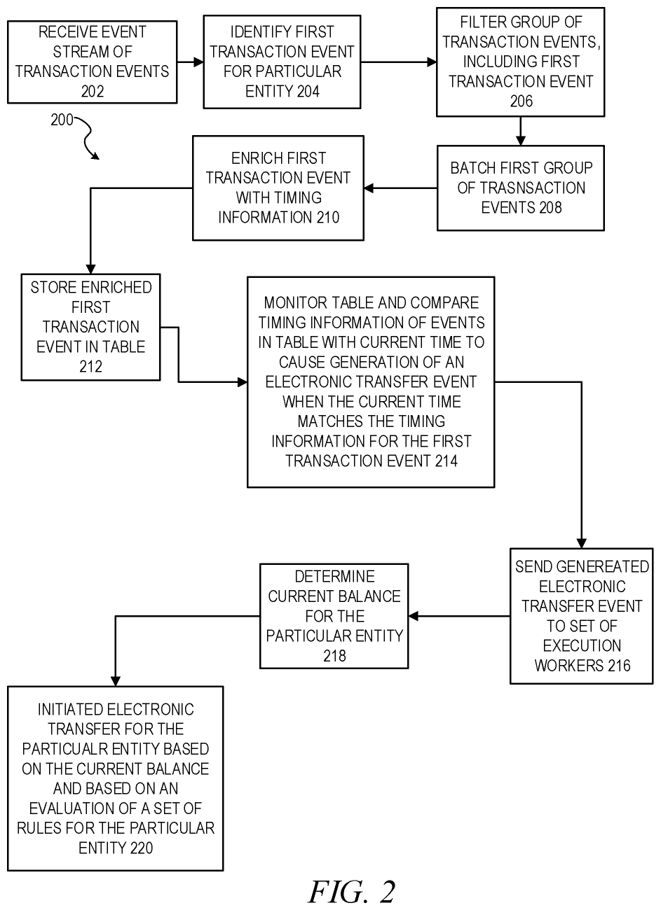

FIG. 2 is a flow diagram illustrating a method 200 of generating and monitoring events in a computer system, in accordance with an example embodiment. At operation 202, an event stream of transaction events is received, each transaction event indicating a transaction amount and An entity (such as a merchant)involved in a corresponding transaction. At operation 204, a first transaction event, in the event stream, for a particular entity may be identified. This may be performed by determining that the first transaction event has an indicated entity matching the particular entity.

At operation 206, a group of transaction events, including the first transaction event, may be filtered. At operation 208, the group of transaction event may be batched. At operation 210, the first transaction event (which may or may not include other transaction events for the particular entity that has been batched with it at operation 208) may be enriched. The enrichment may include adding timing information indicating a beginning time for an electronic transfer including the transaction amount. The timing information may be calculated based on a schedule of electronic transfers for the particular entity, a type of electronic transfer for the particular entity, and an indication of how long the type of electronic transfer takes to process.

At operation 212, the enriched first transaction event may be stored in a table. At operation 214, the table may be monitored and timing information of events in the table may be compared with a current time to cause generation of an electronic transfer event when the current time matches the timing information for the first transaction event. At operation 216, the generated electronic transfer event is sent to a set of execution workers. Operations 202-216 may be performed by a scheduler that is distinct from the execution workers.

At operation 218, the set of execution workers may determine a current balance for the particular entity. This may be performed by querying a balance system that processes incoming transactions. At operation 220, based on evaluation of a set of rules for the particular entity, an electronic transfer for the particular entity is initiated based on the current balance. It should be noted that the current balance may be different than the transaction amount of the first transaction event, due to subsequent transaction events involving the entity having been generated after the first transaction event has been stored in the table. This enables the scheduler to avoid any bottlenecks that may be encountered by the balance system, as essentially only the first transaction event in a group of transaction events for a entity needs to be scheduled by the scheduler, and subsequent transaction events for the entity need not be received, let alone processed, by the scheduler at the time the electronic transfer is to be initiated in order to ensure accuracy of the amount of the electronic transfer.

The set of rules may be indicated by a machine-learned model, which may be trained by passing training data to a machine learning algorithm. At some point (not pictured), the machine-learned model is retrained by passing updated training data to the machine learning algorithm. This retraining may include data regarding results of the electronic transfer.

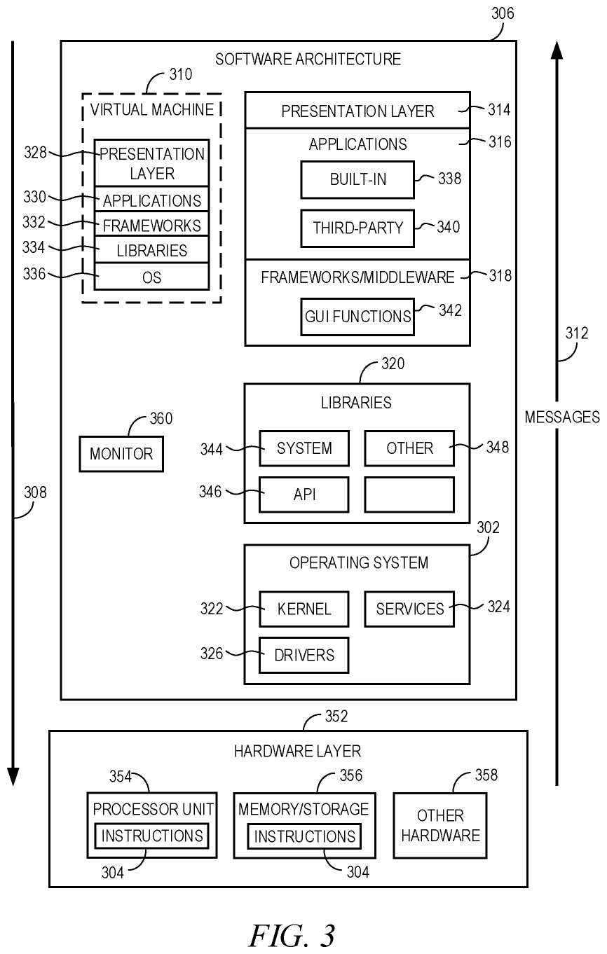

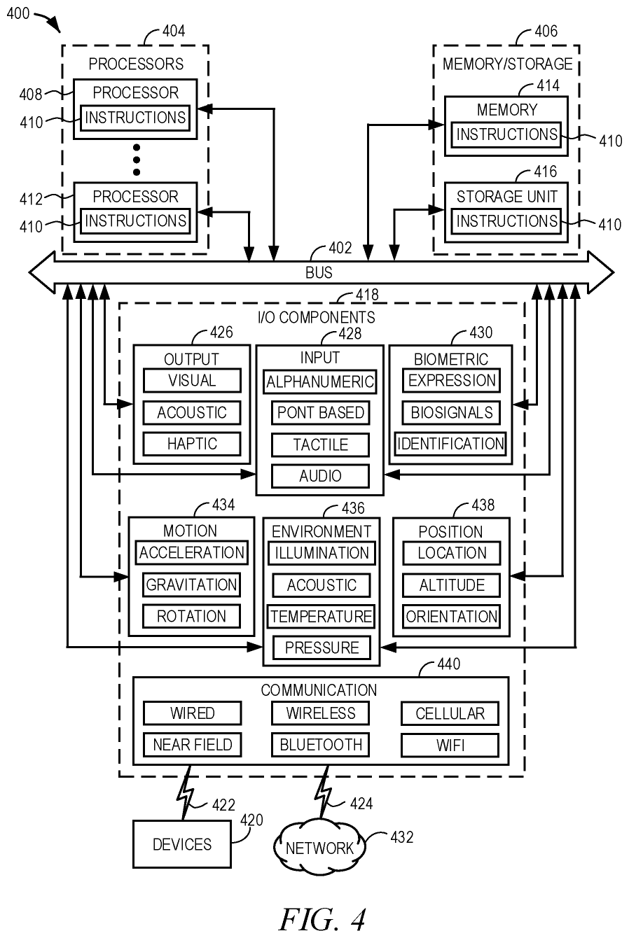

FIG. 3 is a block diagram illustrating an example software architecture 306, which may be used in conjunction with various hardware architectures herein described. FIG. 3 is a non-limiting example of a software architecture 306, and it will be appreciated that many other architectures may be implemented to facilitate the functionality described herein. The software architecture 306 may execute on hardware such as a machine 400 of FIG. 4 that includes, among other things, processors 404, memory/storage 406, and I/O (input/output) components 418. A hardware layer 352 is illustrated and can represent, for example, the machine 400 of FIG. 4. The hardware layer 352 includes a processor 354 having associated executable instructions 304. The associated executable instructions 304 represent the executable instructions of the software architecture 306, including implementation of the methods, components, and so forth described herein. The hardware layer 352 also includes memory and/or storage modules as memory/storage 356, which also have the associated executable instructions 304. The hardware layer 352 may also comprise other hardware 358.

In the example architecture of FIG. 3, the software architecture 306 may be conceptualized as a stack of layers where each layer provides particular functionality. For example, the software architecture 306 may include layers such as an operating system 302, libraries 320, frameworks/middleware 318, applications 316, and a presentation layer 314. Operationally, the applications 316 and/or other components within the layers may invoke API calls 308 through the software stack and receive a response as messages 312 in response to the API calls 308. The layers illustrated are representative in nature, and not all software architectures have all layers. For example, some mobile or special-purpose operating systems may not provide a frameworks/middleware 318, while others may provide such a layer. Other software architectures may include additional or different layers.

The operating system 302 may manage hardware resources and provide common services. The operating system 302 may include, for example, a kernel 322, services 324, and drivers 326. The kernel 322 may act as an abstraction layer between the hardware and the other software layers. For example, the kernel 322 may be responsible for memory management, processor management (e.g., scheduling), component management, networking, security settings, and so on. The services 324 may provide other common services for the other software layers. The drivers 326 are responsible for controlling or interfacing with the underlying hardware. For instance, the drivers 326 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 320 provide a common infrastructure that is used by the applications 316 and/or other components and/or layers. The libraries 320 provide functionality that allows other software components to perform tasks in an easier fashion than by interfacing directly with the operating system 302 functionality (e.g., kernel 322, services 324, and/or drivers 326). The libraries 320 may include system libraries 344 (e.g., C standard library) that may provide functions such as memory allocation functions, string manipulation functions, mathematical functions, and the like. In addition, the libraries 320 may include API libraries 346 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 320 may also include a wide variety of other libraries 348 to provide many other APIs to the applications 316 and other software components/modules.

The frameworks/middleware 318 provide a higher-level common infrastructure that may be used by the applications 316 and/or other software components/modules. For example, the frameworks/middleware 318 may provide various graphic user interface (GUI) functions 342, high-level resource management, high-level location services, and so forth. The frameworks/middleware 318 may provide a broad spectrum of other APIs that may be utilized by the applications 316 and/or other software components/modules, some of which may be specific to a particular operating system or platform.

The applications 316 include built-in applications 338 and/or third-party applications 340. Examples of built-in applications 338 may include, but are not limited to, a contacts application, a browser application, a book reader application, a location application, a media application, a messaging application, and/or a game application. The third-party applications 340 may include any application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 340 may invoke the API calls 308 provided by the mobile operating system (such as the operating system 302) to facilitate functionality described herein.

The applications 316 may use built-in operating system functions (e.g., kernel 322, services 324, and/or drivers 326), libraries 320, and frameworks/middleware 318 to create user interfaces to interact with users of the system. Alternatively, or additionally, in some systems, interactions with a user may occur through a presentation layer, such as the presentation layer 314. In these systems, the application/component “logic” can be separated from the aspects of the application/component that interact with a user.

Some software architectures use virtual machines. In the example of FIG. 3, this is illustrated by a virtual machine 310. The virtual machine 310 creates a software environment where applications/components can execute as if they were executing on a hardware machine (such as the machine 400 of FIG. 4, for example). The virtual machine 310 is hosted by a host operating system (e.g., the operating system 302 in FIG. 3) and typically, although not always, has a virtual machine monitor 360, which manages the operation of the virtual machine 310 as well as the interface with the host operating system (e.g., the operating system 302). A software architecture executes within the virtual machine 310 such as an operating system (OS) 336, libraries 334, frameworks 332, applications 330, and/or a presentation layer 328. These layers of software architecture executing within the virtual machine 310 can be the same as corresponding layers previously described or may be different.

FIG. 4 is a block diagram illustrating components of a machine 400, according to some example embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 410 (e.g., software, a program, an application, an applet, an app, or other executable code) for causing the machine 400 to perform any one or more of the methodologies discussed herein may be executed. As such, the instructions 410 may be used to implement modules or components described herein. The instructions 410 transform the general, machine 400 into a particular machine 400 programmed to carry out the described and illustrated functions in the manner described. In alternative embodiments, the machine 400 operates as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while only a machine 400 is illustrated, the term “machine” shall also be taken to include a collection of machines that individually or jointly execute the instructions 410 to perform any one or more of the methodologies discussed herein.

The machine 400 may include processors 404 (including processors 408 and 412), memory/storage 406, and I/O components 418, which may be configured to communicate with each other such as via a bus 402. The memory/storage 406 may include a memory 414, such as a main memory or other memory storage, and a storage unit 416, both accessible to the processors 404 such as via the bus 402. The storage unit 416 and memory 414 store the instructions 410 embodying any one or more of the methodologies or functions described herein. The instructions 410 may also reside, completely or partially, within the memory 414, within the storage unit 416, within at least one of the processors 404 (e.g., within the processor's cache memory), or any suitable combination thereof, during execution thereof by the machine 400. Accordingly, the memory 414, the storage unit 416, and the memory of the processors 404 are examples of machine-readable media.

The I/O components 418 may include a wide variety of components to receive input, provide output, produce output, transmit information, exchange information, capture measurements, and so on. The specific I/O components 418 that are included in a particular machine will depend on the type of machine. For example, portable machines such as mobile phones will likely include a touch input device or other such input mechanisms, while a headless server machine will likely not include such a touch input device. It will be appreciated that the I/O components 418 may include many other components that are not shown in FIG. 4. The I/O components 418 are grouped according to functionality merely for simplifying the following discussion, and the grouping is in no way limiting. In various example embodiments, the I/O components 418 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 418 may include biometric components 430, motion components 434, environment components 436, or position components 438, among a wide array of other components. For example, the biometric components 430 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 434 may include acceleration sensor components (e.g., accelerometer), gravitation sensor components, rotation sensor components (e.g., gyroscope), and so forth. The environment components 436 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 418 may include communication components 440 operable to couple the machine 400 to a network 432 or devices 420 via a coupling 424 and a coupling 422, respectively. For example, the communication components 440 may include a network interface component or other suitable device to interface with the network 432. In further examples, the communication components 440 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 420 may be another machine or any of a wide variety of peripheral devices (e.g., a peripheral device coupled via a USB).

Moreover, the communication components 440 may detect identifiers or include components operable to detect identifiers. For example, the communication components 440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 440, such as location via Internet Protocol (IP) geo-location, location via Wi-Fi® signal triangulation, location via detecting an NFC beacon signal that may indicate a particular location, and so forth.

“Carrier Signal” in this context refers to any intangible medium that is capable of storing, encoding, or carrying instructions for execution by a machine, and includes digital or analog communication signals or other intangible media to facilitate communication of such instructions. Instructions may be transmitted or received over a network using a transmission medium via a network interface device and using any one of a number of well-known transfer protocols.

“Client Device” or “Electronic Device” in this context refers to any machine that interfaces to a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronic system, game console, set-top box, or any other communication device that a user may use to access a network.

“Customer's Electronic Device” or “Electronic User Device” in this context refers to a client device that a customer uses to interact with a merchant. Examples of this device include a desktop computer, a laptop computer, a mobile device (e.g., smart phone, tablet), and a game console. The customer's electronic device may interact with the merchant via a browser application that executes on the customer's electronic device or via a native app installed onto the customer's electronic device. The client-side application executes on the customer's electronic device.

“Communications Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 6G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“Component” in this context refers to a device, physical entity, or logic having boundaries defined by function or subroutine calls, branch points, application programming interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors.

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instant in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instant of time and to constitute a different hardware component at a different instant of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a machine but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Readable Medium” in this context refers to a component, device, or other tangible medium able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals.

“Processor” in one context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011-2021, Stripe, Inc., All Rights Reserved.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving an event stream of transaction events, each transaction event indicating a transaction amount and an entity involved in a corresponding transaction;
for a particular entity, identifying a first transaction event in the event stream, the first transaction event having an indicated entity matching the particular entity;
enriching the first transaction event with timing information indicating a beginning time for an electronic transfer including the transaction amount;
storing the enriched first transaction event in a table;
monitoring the table and comparing timing information of events in the table with a current time to cause generation of an electronic transfer event when the current time matches the timing information for the first transaction event;
passing the generated electronic transfer event to a set of execution workers;
determining, by the set of execution workers, a current balance for the particular entity; and
based on evaluation of a set of rules for the particular entity, initiating an electronic transfer for the particular entity based on the current balance.

2. The method of claim 1, wherein the current balance is different than the transaction amount of the first transaction event, due to subsequent transaction events having been generated involving the entity after the first transaction event has been stored in the table.

3. The method of claim 1, wherein the set of rules are indicated by a machine-learned model.

4. The method of claim 3, wherein the machine-learned model is trained by passing training data to a machine learning algorithm.

5. The method of claim 4, further comprising retraining the machine-learned model by passing updated training data to the machine learning algorithm.

6. The method of claim 5, wherein the updated training data includes data regarding results of the electronic transfer.

7. The method of claim 1, wherein the first transaction event is joined with other transaction events for the particular entity prior to the enriching.

8. The method of claim 1, wherein the timing information is calculated based on a schedule of electronic transfers for the particular entity, a type of electronic transfer for the particular entity, and an indication of how long the type of electronic transfer takes to process.

9. The method of claim 1, wherein the event stream is received from a balance system that processes incoming transactions and outputs a transaction event for each processed transaction.

10. A system comprising:
one or more processors; and
a memory storing instructions that, when executed by at least one processor among the one or more processors, cause the at least one processor to perform operations comprising:
receiving an event stream of transaction events, each transaction event indicating a transaction amount and an entity involved in a corresponding transaction;
for a particular entity, identifying a first transaction event in the event stream, the first transaction event having an indicated entity matching the particular entity;
enriching the first transaction event with timing information indicating a beginning time for an electronic transfer including the transaction amount;
storing the enriched first transaction event in a table;
monitoring the table and comparing timing information of events in the table with a current time to cause generation of an electronic transfer event when the current time matches the timing information for the first transaction event;
passing the generated electronic transfer event to a set of execution workers;
determining, by the set of execution workers, a current balance for the particular entity; and
based on evaluation of a set of rules for the particular entity, initiating an electronic transfer for the particular entity based on the current balance.

11. The system of claim 10, wherein the current balance is different than the transaction amount of the first transaction event, due to subsequent transaction events having been generated involving the entity after the first transaction event has been stored in the table.

12. The system of claim 10, wherein the set of rules are indicated by a machine-learned model.

13. The system of claim 12, wherein the machine-learned model is trained by passing training data to a machine learning algorithm.

14. The system of claim 13, further comprising retraining the machine-learned model by passing updated training data to the machine learning algorithm.

15. The system of claim 14, wherein the updated training data includes data regarding results of the electronic transfer.

16. The system of claim 10, wherein the first transaction event is joined with other transaction events for the particular entity prior to the enriching.

17. The system of claim 10, wherein the timing information is calculated based on a schedule of electronic transfers for the particular entity, a type of electronic transfer for the particular entity, and an indication of how long the type of electronic transfer takes to process.

18. The system of claim 10, wherein the event stream is received from a balance system that processes incoming transactions and outputs a transaction event for each processed transaction.

19. A non-transitory machine-readable medium comprising instructions which, when read by a machine, cause the machine to perform operations comprising:
receiving an event stream of transaction events, each transaction event indicating a transaction amount and an entity involved in a corresponding transaction;
for a particular entity, identifying a first transaction event in the event stream, the first transaction event having an indicated entity matching the particular entity;
enriching the first transaction event with timing information indicating a beginning time for an electronic transfer including the transaction amount;
storing the enriched first transaction event in a table;
monitoring the table and comparing timing information of events in the table with a current time to cause generation of an electronic transfer event when the current time matches the timing information for the first transaction event;
passing the generated electronic transfer event to a set of execution workers;
determining, by the set of execution workers, a current balance for the particular entity; and
based on evaluation of a set of rules for the particular entity, initiating an electronic transfer for the particular entity based on the current balance.

20. A non-transitory machine-readable medium of claim 19, wherein the current balance is different than the transaction amount of the first transaction event, due to subsequent transaction events having been generated involving the entity after the first transaction event has been stored in the table.
